(19) United States
(12) Patent Application Publication
(10) Pub. No.: US 2003/0012158 A1
(43) Pub. Date: Jan. 16, 2003

(54) System and method for synchronizing a base station in a distributed radio system

(76) Inventors: Hang Jin, Plano, TX (US); Paul Nelson, Frisco, TX (US); Joseph R. Cleveland, Richardson, TX (US); Sanjay Kulkarni, Plano, TX (US)

Correspondence Address: William A. Munck, Esq., NOVAKOV DAVIS & MUNCK, P.C., 900 Three Galleria Tower, 13155 Noel Road, Dallas, TX, 75240, US

(21) Appl. No.: 09/769,594

(22) Filed: Jan. 25, 2001

(51) Int. Cl. H04L 12/413; H04J 3/06; H04B 7/216

(52) U.S. Cl. 370/335; 370/503; 370/445

(57) ABSTRACT

There is disclosed a system and method for synchronizing a base station within a distributed radio system. A communication network is provided utilizing gigabit ethernet protocols and media. A global positioning system (GPS) is installed onboard one of a plurality of base stations. The single GPS, without the necessity for a holdover oscillator, is used to synchronize a plurality of the base stations within the network by transmitting a clock signal via the gigabit ethernet media to each base station. The gigabit Ethernet signal is tapped by a clock recovery circuit, present on each base station and the recovered signal serves as a master clock signal for the base station as well as a reference clock for the transmit and receive section.

### TECHNICAL FIELD OF THE INVENTION

The present invention is directed, in general, to wireless communication and more specifically, to a system for synchronizing base stations in a distributed radio system.

### BACKGROUND OF THE INVENTION

A distributed radio system for wireless indoor applications consists of numerous remote base stations connected to a centrally located base-band digital unit utilizing Ethernet protocol. Compared to conventional systems, a distributed radio system can provide an optimum Radio Frequency coverage while at the same time maintaining a high traffic trunking and component pooling efficiency for the base-band digital unit. Previous distributed radio approaches include fiber systems, radiating coaxial cables, coaxial cables and combinations of these approaches, all costly.

Wireless telecommunications networks must be synchronized in order to be effective. The entire network must be controlled by one master clock so that transmissions are completed without losing or adding information to the transmission. Base stations within the networks must be synchronized with each other and with the master clock. For synchronizing timing of the base stations, one embodiment for conventional systems typically provides a hard-wired synchronization line which couples each base station in the system to the master clock at the controller. Each base station establishes its timing in response to timing signals on the synchronization line. Handsets in the region near the base station synchronize to the timing established at the base station. In another embodiment, a Code Division Multiple Access (CDMA) system utilizes an installed Global Positioning System (GPS) in each base station. CDMA systems require (per IS-95 standard) that all base stations transmit their pilot sequence within 3 microseconds of the precise CDMA system time. The GPS provides extremely accurate time and frequency synchronization by connecting individual base stations in the CDMA network to the United States Naval Observatory atomic clock.

Normally, GPS receivers are relatively inexpensive. However, a holdover stable oscillator (HSO) is required in each base station in case the GPS receiver goes offline. The need for holdover time (loss of the GPS signal), typically anywhere from eight to 24 hours, increases the cost of GPS synchronization. A standby HSO is used alongside the GPS in CDMA base stations, usually a rubidium or an “ovenized” quartz crystal oscillator, which adds significant cost to network deployments. Each GPS is coupled with a local crystal oscillator on board the base station. The GPS receiver “disciplines” (calibrates) the local oscillator, by making minor changes to the bias to stabilize the oscillator for at least a certain period of time. The requirement to provide a GPS and HSO on each Base Station is necessary, but very costly.

Therefore, there is a need in the art for providing a system and method that will reduce the necessity for providing a GPS and HSO on every base station in a network. There is also a need to provide a single source as a master clock for synchronizing all the base stations in the network.

### SUMMARY OF THE INVENTION

To address the above-discussed deficiencies of the prior art, it is a primary object of the present invention to provide a method and system for synchronizing a base station with a master clock in a CDMA network.

It is another object of the present invention to reduce the need for a high stability oscillator and global positioning system on each base station in a CDMA network.

The foregoing objects are achieved as is now described. A telecommunication network is provided utilizing gigabit ethernet protocols and media. A global positioning system (GPS) and holdover stable oscillator (HSO) are installed aboard one of a plurality of base stations. The single CPS and HSO are used to synchronize all the base stations within the network by transmitting a clock signal via the gigabit ethernet media to each base station. The gigabit Ethernet signal is tapped by a clock recovery circuit, present in each base station, and the recovered signal serves as the master clock signal for the base station as well as a reference clock for the transmit and receive section.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a general overview of an exemplary wireless network according to one embodiment of the present invention;

FIG. 2 illustrates in greater detail an exemplary base station in accordance with one embodiment of the present invention;

FIG. 3 depicts a high-level block diagram of a distributed radio system in accordance with an embodiment of the present invention;

FIG. 4 illustrates a high-level block diagram of a base station in accordance with a preferred embodiment of the present invention;

FIG. 5 depicts a high-level block diagram of a clock recovery circuit for recovering the system clock, in accordance with a preferred embodiment of the present invention, is depicted; and

FIG. 6 illustrates a high-level flow diagram of a process for synchronizing a base station in a CDMA network, using gigabit ethernet, in accordance with the present invention.

### DETAILED DESCRIPTION OF THE INVENTION

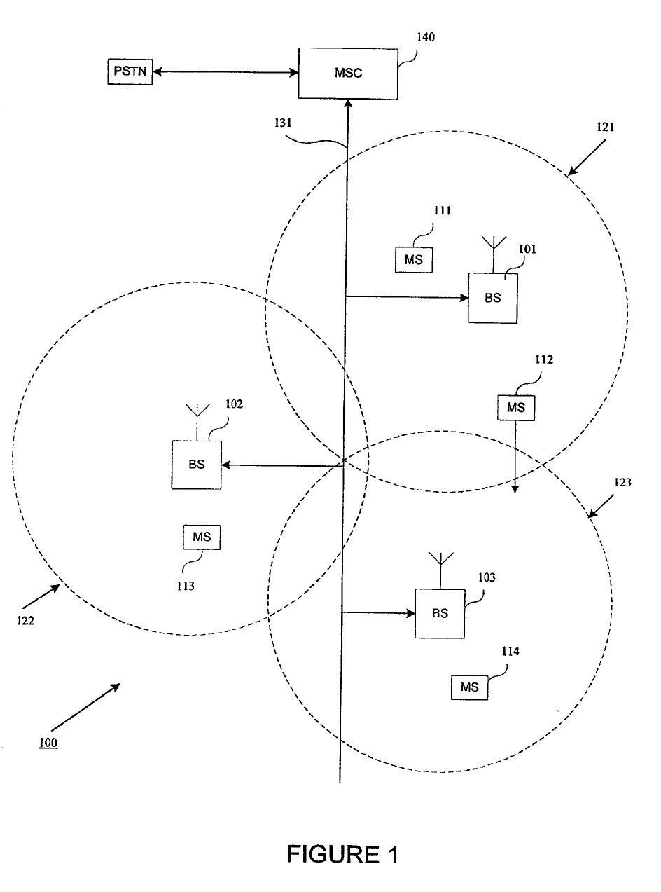

FIGS. 1 through 6, discussed below, and the various embodiments used to describe the principles of the present invention in this patent document, are by way of illustration only and should not be construed in any way to limit the scope of the invention. Those skilled in the art will understand that the principles of the present invention may be implemented in any suitably arranged wireless network. For instance, the principles of the present invention may be implemented in a distributed radio system for wireless indoor applications. A wireless office would comprise numerous base stations connected to a centrally located base-band digital unit via gigabit Ethernet protocol.

FIG. 1 illustrates a general overview of exemplary wireless network 100 according to an embodiment of the present invention. Wireless network 100 comprises a plurality of cell sites 121-123, each containing one of the base stations, BS 101, BS 102, or BS 103. Base stations 101-103 are operable to communicate with a plurality of mobile stations (MS) 111-114. Mobile stations 111-114 may be any suitable wireless communication devices, including conventional cellular telephones, PCS handset devices, portable computers, telemetry devices, and the like.

Dotted lines show the approximate boundaries of the cell sites 121-123 in which base stations 101-103 are located. The cell sites are shown approximately circular for the purposes of illustration and explanation only. It should be clearly understood that the cell sites also may have irregular shapes, depending on the cell configuration selected and both natural and man-made obstructions.

In one embodiment of the present invention, BS 101, BS 102, and BS 103 may comprise a base station controller (BSC) and a base transceiver station (BTS). Base station controllers and base transceiver stations are well known to those skilled in the art. A base station controller is a device that manages wireless communications resources, including the base transceiver station, for specified cells within a wireless communications network. A base transceiver station comprises the RF transceivers, antennas, and other electrical equipment located in each cell site. This equipment may include air conditioning units, heating units, electrical supplies, telephone line interfaces, and RF transmitters and RF receivers, as well as call processing circuitry. For the purpose of simplicity and clarity in explaining the operation of the present invention, the base transceiver station in each of cells 121, 122, and 123 and the base station controller associated with each base transceiver station are collectively represented by BS 101, BS 102 and BS 103, respectively.

BS 101, BS 102 and BS 103 transfer voice and data signals between each other and the public telephone system (not shown) via communications line 131 and mobile switching center (MSC) 140. Mobile switching center 140 is well known to those skilled in the art. Mobile switching center 140 is a switching device that provides services and coordination between the subscribers in a wireless network and external networks, such as the public telephone system and/or the Internet. Communications line 131 may be any suitable connection means, including a T1 line, a T3 line, a fiber optic link, a network backbone connection, and the like. In some embodiments of the present invention, communications line 131 may be several different data links, where each data link couples one of BS 101, BS 102, or BS 103 to MSC 140.

In the exemplary wireless network 100, MS 111 is located in cell site 121 and is in communication with BS 101, MS 113 is located in cell site 122 and is in communication with BS 102, and MS 114 is located in cell site 123 and is in communication with BS 103. MS 112 is also located in cell site 121, close to the edge of cell site 123. The direction arrow proximate MS 112 indicates the movement of MS 112 towards cell site 123. At some point, as MS 112 moves into cell site 123 and out of cell site 121, a “handoff” will occur. Successful hand off requires time synchronization between the base stations.

As is well known, the “handoff” procedure transfers control of a call from a first cell to a second cell. For example, if MS 112 is in communication with BS 101 and senses that the signal from BS 101 is becoming unacceptably weak, MS 112 may then switch to a BS that has a stronger signal, such as the signal transmitted by BS 103. MS 112 and BS 103 establish a new communication link and a signal is sent to BS 101 to route the on-going voice, data, or control signals through BS 103. In soft hand off, voice, data and control signals occur between MS 112 and both BS 101 and BS 103. The call is thereby seamlessly transferred from BS 101 to BS 103. An “idle” handoff is a handoff between cells of a mobile device that is communicating in the control or paging channel, rather than transmitting voice and/or data signals in the regular traffic channels.

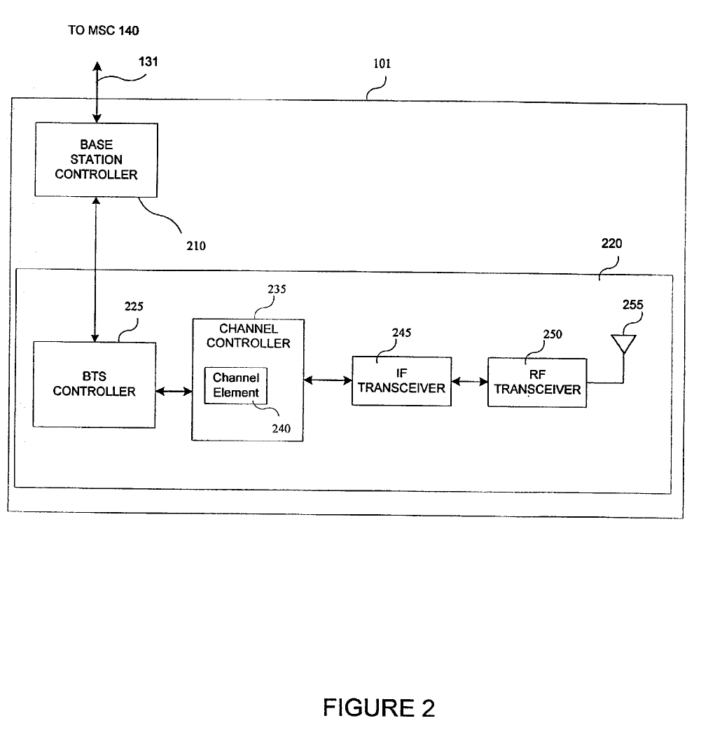

FIG. 2 illustrates in greater detail exemplary base station 101 in accordance with one embodiment of the present invention. Base station 101 comprises base station controller (BSC) 210 and base transceiver station (BTS) 220. Base station controllers and base transceiver stations were described previously in connection with FIG. 1. BSC 210 manages the resources in cell site 121, including BTS 220. BTS 220 comprises BTS controller 225, channel controller 235, which contains representative channel element 240, transceiver interface (IF) 245, RF transceiver unit 250 and antenna array 255.

BTS controller 225 comprises processing circuitry and memory capable of executing an operating program that controls the overall operation of BTS 220 and communicates with BSC 210. Under normal conditions, BTS controller 225 directs the operation of channel controller 235, which contains a number of channel elements, including channel element 240, that perform bi-directional communications in the forward channel and the reverse channel. A “forward” channel refers to outbound signals from the base station to the mobile station and a “reverse” channel refers to inbound signals from the mobile station to the base station. In an advantageous embodiment of the present invention, the channel elements operate according to a code division multiple access (CDMA) protocol with the mobile stations in cell 121. Transceiver IF 245 transfers the bi-directional channel signals between channel controller 240 and RF transceiver unit 250.

Antenna array 255 transmits forward channel signals from RF transceiver unit 250 to mobile stations in the coverage area of BS 101. Antenna array 255 also sends to transceiver 250 reverse channel signals received from mobile stations in the coverage area of BS 101. In a preferred embodiment of the present invention, antenna array 255 is multi-sector antenna, such as a three sector antenna in which each antenna sector is responsible for transmitting and receiving in a 1200 arc of coverage area. Additionally, RF transceiver 250 may contain an antenna selection unit to select among different antennas in antenna array 255 during both transmit and receive operations.

For accurate communication between base stations and mobile stations the time bases of each must be synchronized. For synchronization, a master clock or timing signal that is generated by a Global Positioning Receiver in one Base Station is conveyed to other base stations controlled by the same MSC. Currently, all base stations have a GPS and a holdover oscillator, all synched to the GPS time. The present invention eliminates the need for a GPS receiver and holdover stable oscillator in each Base Station by tapping the incoming gigabit ethernet signal and recovering an accurate synchronizing signal. A single GPS receiver and HSO is installed in one Base Station and utilized to synchronize other nearby Base Stations.

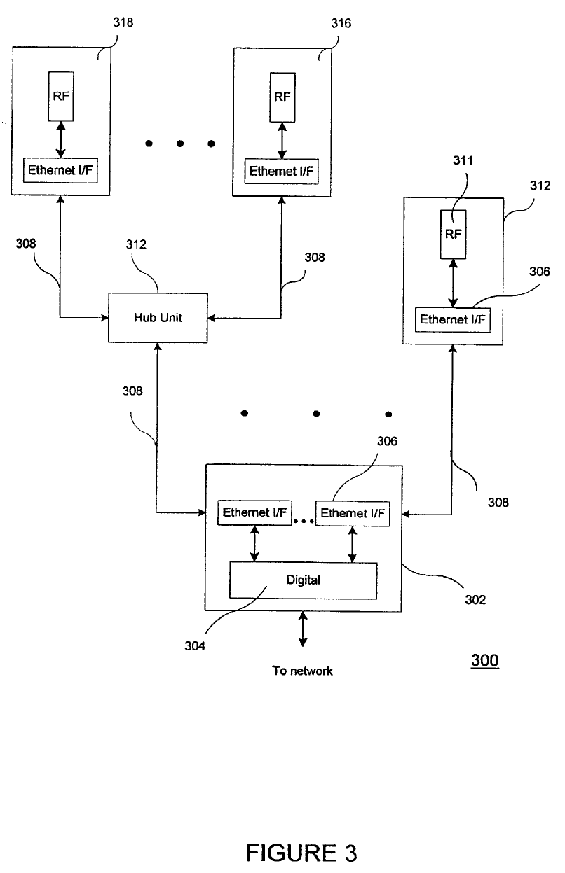

FIG. 3 depicts a high-level block diagram of a distributed radio system in accordance with an embodiment of the present invention. The distributed radio system may be used in wireless indoor applications, for both voice and data traffic, where distances between base stations are relatively small in comparison to outdoor wireless applications. A large building may utilize a CDMA wireless system and require several base stations per floor for handling multiple handsets (mobile stations). With the present invention only one base station per floor would require a GPS receiver and HSO.

Distributed radio system 300, utilizing Gigabit Ethernet (GE), comprises a centrally located digital unit 302 with analog to digital converter 304; remote base stations 312, 316 and 318, each including a GE interface card 306, and radio frequency (RF) receiver 310; gigabit transport media 308 and hub unit 314 (handsets and mobile stations that are linked to base stations are not shown).

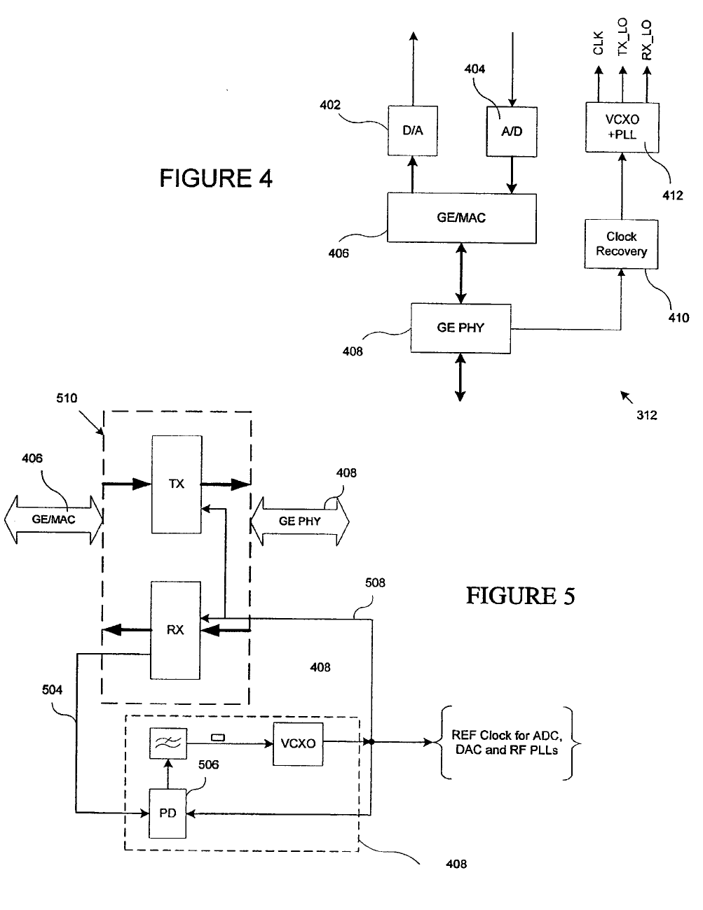

An RF signal is received at base station 312, and converted to a digital signal. The digital signal is converted to a gigabit signal then sent to digital unit 302 over gigabit media 308 (may be copper or UTP-5 cables) using gigabit Ethernet protocols. The gigabit Ethernet clock is synchronized to a reference signal from the GS or HSO. Depending on the distance between base station 312 and digital unit 302, hub unit 314 may be required to boost the signal. The signal is received by gigabit ethernet interface card 306 in digital unit 302 and transferred to the network that is linked to distributed radio system 300. The opposite is done for the forward link where a signal is received via the network into digital unit 302 and transferred to base station 312 via ethernet interfaces 306 and gigabit media 308. The operation of Base Station 312, in relation to this embodiment of the present invention will be explained more fully in FIG. 4.

Referring now to FIG. 4, a high-level block diagram of a base station in accordance with a preferred embodiment of the present invention, is illustrated. Base station 312, in a gigabit ethernet system, includes a RF section and a gigabit Ethernet interface. Base Station 312 is shown with GE Media Access Control (GE/MAC) 406 and GE Physical layer (GE/PHY) communication functions illustrated. GE/MAC 406 handles access to shared media, such as whether token passing or contention will be used during the transmission of gigabit signals. GE/PHY 408, which includes transmit and recovery paths, defines the electrical, mechanical, procedural, and functional specifications for activating, maintaining, and deactivating the physical link between the GE end systems. In the present invention GE PHY is a one gigabit data stream being received by the base station from the network.

Digital to Analog converter (DIA) 402, transmits signals that have been derived from digital gigabit ethernet signals received into base station 312. Analog to Digital converter (A/D) 404, receives a signal from a mobile station (not shown) and converts the signal, which is then transmitted, via a gigabit interface to the gigabit ethernet media. Clock recovery circuit 410, with more discussion in FIG. 5, taps a gigabit clock signal in a gigabit transceiver chip and is used to recover the system clock as received into base station 312. Voltage Controlled Crystal Oscillator (VCXO) 412 is combined with a phase locked loop for frequency tracking and clock recovery.

Referring now to FIG. 5, a high-level block diagram of a clock recovery circuit for recovering the system clock, in accordance with a preferred embodiment of the present invention, is depicted. Voltage-controlled crystal oscillators (VCXO) play a key role in circuits where clock recovery is essential. The VCXO must lock onto and reconstruct an incoming high-frequency signal to strip away and remove noise and maintain a specific frequency under varying temperature and load conditions.

Transceiver chip 510 receives gigabit transmission signal 408 from the network via gigabit transmission media. Gigabit signal 408 (generated by the station that is driving the network clock) is tapped by clock recovery circuit 410 and received into phase detector 506. The VCXO 412 utilizes the signal to generate a signal that is then sent back to phase detector 506 to TX local oscillator 514 to continuously confirm and adjust the signal. The signal is also sent to RX local oscillator 516 and TX local oscillator 518 as a reference clock to synchronize the local oscillators. Further, the reference clock signal is sent to the A/D and D/A converters and RF PLLs to complete synchronization for the base station. By synchronizing the base station local oscillators to the GPS-synchronized gigabit Ethernet signal, the base station is synchronized to the GPS reference.

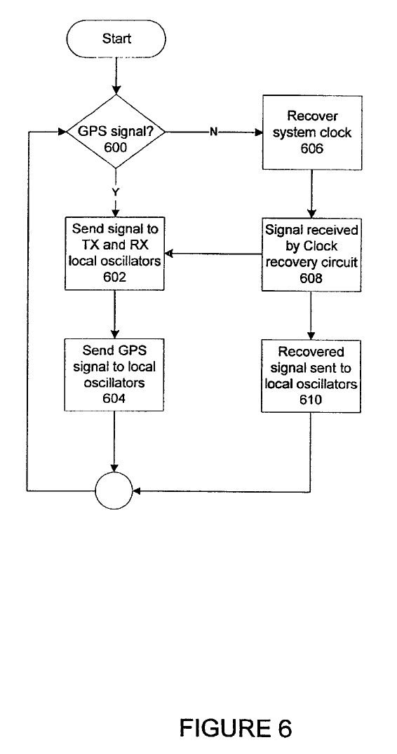

Referring now to FIG. 6, a high-level flow diagram of a process for synchronizing a base station in a CDMA network using gigabit ethernet, in accordance with the present invention, is illustrated. A GPS for to be used for synchronization can be located in one of a plurality of base stations in the network. The GPS clock signal is transmitted via gigabit transmission media to all the base stations. The process begins with step 600, which depicts a determination, at a base station, of whether a GPS signal is available for synchronizing a base station. If a GPS or HSO signal is available, the process passes to step 602, which illustrates the clock signal being received to synchronize the base station with all the other base stations. The process continues to step 604, which depicts the signal being sent to the transmit and receive local oscillators of the base station as a master clock signal. The clock signal is also sent to the base station transmitter section and locked reference clock for the receiver section. The process then continues to step 600.

If it is determined that the GPS clock signal is not available, the process proceeds to step 606, which illustrates tapping the gigabit data stream being received into the base station and the signal being sent to a clock recovery circuit. The process continues to step 608, which depicts the clock recovery circuit processing the received signal. The process passes to step 610, which illustrates the recovered signal being sent to the transmit and receive local oscillators of the base station as a master clock signal. Additionally, the clock signal is sent to the base station transmitter section and locked reference clock for the receiver section. The process continues to step 600 to determine if a GPS clock signal is available.

In the present invention, a base station, utilizing a gigabit ethernet, is synchronized with mobile switching center clock by utilizing the incoming data stream from the network. The system clock is recovered from transitions of the data stream A follow up PLL circuit cleans up the phase noise caused by data rising or falling edge jitters. The cleaned up clock signal serves as the master clock for the base station as well as the reference clock for the transmitter section and locked reference clock for the receiver section The VCXO is utilized in the PLL circuit because of its low phase noise and excellent frequency stability.

Although the present invention has been described in detail, those skilled in the art should understand that they can make various changes, substitutions and alterations herein without departing from the spirit and scope of the invention in its broadest form.

What is claimed is:

1. For use in a code division multiple access (CDMA) wireless network, a system for synchronizing a plurality of base stations, comprising:
a gigabit ethernet network for interconnecting said plurality of base stations;
a global positioning system (GPS) receiver and a holdover stable oscillator in one of said plurality of base stations for receiving a regulated clock signal; and
a clock recovery circuit, in at least one other of said plurality of base stations, wherein said circuit utilizes said regulated clock signal retrieved from a data stream, from said gigabit Ethernet network, for generating a synchronizing master clock signal for said at least one other of said plurality of base stations.

2. The system for synchronizing a plurality of base stations as set forth in claim 1, further comprising a controller for sending said GPS regulated clock signal to said at least one other of said plurality of base stations.

3. The system for synchronizing a plurality of base stations as set forth in claim 1, further comprising:
a gigabit transceiver circuit, in said at least one other of said plurality of base stations, for processing gigabit Ethernet transmissions.

4. The system for synchronizing a plurality of base stations as set forth in claim 3, further comprising:
a connector for coupling said clock recovery circuit to said gigabit transceiver.

5. The system for synchronizing a plurality of base stations as set forth in claim 4, further comprising:
a receiver portion of said gigabit transceiver circuit being coupled with said clock recovery circuit for retrieving a transmitted GPS clock signal.

6. The system for synchronizing a plurality of base stations as set forth in claim 5, further comprising:
a voltage compensated crystal oscillator for generating said synchronizing signal for said one other of said plurality of base stations.

7. The system for synchronizing a plurality of base stations as set forth in claim 5, further comprising:
a synchronizing signal being generated and sent to said receiver portion, and a transmitter portion, of said gigabit ethernet transceiver circuit

8. For use in a distributed radio system, a Code Division Multiple Access wireless system utilizing Gigabit Ethernet protocols, comprising:
a local area network;
a plurality of base stations; and
a system for synchronizing said plurality of base stations, comprising:
a gigabit ethernet network for interconnecting said plurality of base stations;
a global positioning system (GPS) receiver and a holdover stable oscillator in one of said plurality of base stations for receiving a regulated clock signal; and
a clock recovery circuit, in at least one other of said plurality of base stations, wherein said circuit utilizes a clock signal retrieved from a data stream, being received from said gigabit Ethernet network, for generating a synchronizing master clock signal for said at least one other of said plurality of base stations.

9. The distributed radio system as set forth in claim 8, further comprising a controller for sending said GPS regulated clock signal to said at least one other of said plurality of base stations.

10. The distributed radio system as set forth in claim 8, further comprising:
a gigabit transceiver circuit, in said at least one other of said plurality of base stations, for processing gigabit Ethernet transmissions.

11. The distributed radio system as set forth in claim 10, further comprising:
a connection for coupling said clock recovery circuit to said gigabit transceiver.

12. The system for synchronizing a plurality of base stations as set forth in claim 9, further comprising:
a receiver portion of said gigabit transceiver circuit being coupled with said clock recovery circuit for retrieving a transmitted GPS clock signal.

13. The system for synchronizing a plurality of base stations as set forth in claim 12, further comprising:
a synchronizing signal being generated and sent to said receiver portion, and a transmitter portion, of said gigabit ethernet transceiver circuit

14. The system for synchronizing a plurality of base stations as set forth in claim 12, further comprising:
a voltage compensated crystal oscillator for generating said synchronizing signal for said one other of said plurality of base stations.

15. For use in a gigabit ethernet communication system, a method for synchronizing a plurality of base stations, comprising the steps of:
receiving a regulated clock signal into a GPS receiver installed in one of said plurality of base stations;
responsive to a determination that said GPS receiver is offline, utilizing a holdover stable oscillator to generate said clock signal;
utilizing gigabit Ethernet media to transmit said clock signal from said GPS receiver to at least one other base station; and
generating a synchronizing, master clock signal from a received said clock signal for synchronizing said at least one other of said plurality of base stations.

16. The method for synchronizing a base station as set forth in claim 15, further comprising the steps of:
determining whether said GPS receiver is online; and
utilizing a clock recovery circuit to generate a synchronizing, master clock signal for said at least one other of said plurality of said base stations.

17. The method for synchronizing a base station, as set forth in claim 14, further comprising the step of:
processing gigabit Ethernet transmissions with a gigabit transceiver circuit in said at least one other of said plurality of base stations.

18. The system for synchronizing a plurality of base stations as set forth in claim 17, further comprising:
coupling said clock recovery circuit with a receiver portion of said gigabit transceiver circuit for retrieving a GPS regulated clock signal; and
utilizing said retrieved GPS regulated clock signal for generating:
a master clock signal for said one other of said plurality of said base stations; and
a reference signal for said receiver portion, and a transmitter portion, of said gigabit Ethernet transceiver circuit.
